(19) United States
(12) Patent Application Publication
(10) Pub. No.: US 2005/0040620 A1
(43) Pub. Date: Feb. 24, 2005

(54) Manually powered vehicle

(75) Inventors: Chenghao Piao, Changchun (CN); Yuze Luo, Changchun (CN)

Correspondence Address: Hool International LLC, 7782 E. Castle Valley Way, Tucson, AZ, 85750, US

(73) Assignee: Hool International LLC, Tucson, AZ (US)

(21) Appl. No.: 10/647,036

(22) Filed: Aug. 23, 2003

(51) Int. Cl. B62M 1/00

(52) U.S. Cl. 280/253

(57) ABSTRACT

A manpower vehicle driven by body weight is described herein, characterized in that, using a Cheng-Ze drive mechanism whose input shaft and output shaft that run parallel can transforms the swing motion of input shaft into one-way rotation of output shaft to replace the current drive mechanism consisted of crank, chain wheel and chain. This manpower vehicle has advantages such as increasing driving force remarkably, increasing speed, lessening manpower consumed compared with the current vehicle. Furthermore, all transmission parts are mounted in a small closed body, this mechanism is simple and compact in structure, efficiency of transmission is high, performance of dustproof and waterproof is excellent, lubrication is sufficient, maintenance is convenient and life duration is long. It is a substitute for current man power drive vehicles.

### BACKGROUND OF THE INVENTION

1. Field of the Invention

The present invention relates to a manpower vehicle driven by bodyweight, such as two-wheel-vehicle, three-wheel-vehicle, four-wheel-vehicle, water-bicycle, small boat and manpower aircraft, etc.

2. Description of the Related Art

Today, except handcart, all riding vehicles such as one-wheel-vehicle, two-wheel-vehicle, three-wheel vehicle and that are pedaled by leg, driven by leg force. If the driving time is longer, or a load is much more weight, or the speed is going to increase, or a person pedal vehicle up a inclined roadway, he must consume his body energy continually or increase the driving force ceaselessly, which makes him feel tired quickly, so the main disadvantage of manpower drive vehicle is that it is restricted by leg force, the driving force is little, the energy consumed is more, is difficult to keep the original drive power longer, and the speed is not fast. So people has been exploring how to increase the driving force of the manpower drive vehicle since the bicycle was invented 200 years ago. Then as a result, the motorcycle and auxiliary drive vehicle were invented and developed, but they must use a drive device of internal-combustion engine or electromotor which must consume other energy, and which leads their volume and weight increased. So they can not replace manpower drive vehicle that consumes no other energy. For this motive, people are exploring ceaselessly and some gear change mechanisms are invented, the material and structure of wheel or bodywork are improved in order to decrease weight, increase transmission efficiency, lessen manpower consumed and increase speed. But all these improvement can not achieve the purpose of increasing the driving force without outside energy being consumed.

All bicycle riders can experience that when they are going down an inclined roadway, the bicycle will move down automatically and its speed will be greater and greater without pedaling by feet, it is the force of weight that is working. During this process, riders consume no outside energy. In bicycle games, we can see that all players are using stand-up posture to drive when up an inclined roadway, and they all will use sit-down-posture to drive as soon as the ascent road is finished. This illuminates that rider's maximal driving force is his body weight. The two phenomena adequately illuminate that people have known the truth that their weight can be used to drive bicycle and the driving force can be increased greatly. But if people ride current bicycle and use stand-up posture to drive, the driving force can be increased to rider's weight instantaneously, and the rider will feel arduous awfully, discommodious and not steady in riding, so this stand-up posture can be kept up only in a short time. The reason is that traditional drive mechanism comprising crank, chain wheel and chain is not suitable to drive by body weight with stand-up posture. So the key point is to invent an effectual and convenient and comfortable drive mechanism driven by weight to realize the manpower drive vehicle whose driving force and speed can be increased without consuming outside energy.

### SUMMARY OF THE INVENTION

The present invention is directed to a kind of manpower drive vehicle driven by body weight, characterized in that, it consumes no outside energy, and increases driving force only by body weight and increases speed, and reduces body energy consumed and can be driven conveniently and comfortably for a long time. This vehicle will let the rider pedal the left and right pedal up and down alternately with his left or right foot conveniently and comfortably, thus the driving force can be increased to weight same all along, the speed can be increased and body energy consumed can be reduced, then it can be comfortably driven by body weight for a long time.

The invention is realized as follow: An manpower drive vehicle driven by weight are provided with a kind of drive mechanism which can transform the input shaft's swing motion into output shaft's one-way rotation and in which the input shaft and the output shaft run parallel. This mechanism replaces the current drive mechanism comprising crank, chain wheel and chain. The new mechanism is called Cheng-Ze drive mechanism for short by its inventor. Cheng-Ze drive mechanism is mounted on the output shaft in front of the airtight wheel box; and a pedal mechanism is designed for driving, which can be pedaled up and down alternately with left and right foot; and a coupling (universal) and a force-transmitting link are connected with the output shaft which is extended from back of the wheel box; and a pair of bevel gears used to drive the vehicle wheel rotating are mounted on the other end of force-transmitting link and wheel axle respectively; and the output shaft, the coupling (universal), the force-transmitting link and the bevel gears (or annular gears) are all mounted inside a closed box; and the wheel box and the wheel shaft are connected through closed pipe.

Wherein the Cheng-Ze drive mechanism above, inside the wheel box, a chain wheel with pawl and a gear with pawl are mounted on the input shaft and the two pawls are in facing or reverse direction; and correspondingly, a chain wheel and a gear are mounted on the output shaft; and the chain wheels on the input shaft and the output shaft are driven through a chain, and the two gears on input shaft and output shaft are driving by meshing; and the output shaft can rotate only clockwise or anticlockwise according to the orientation of the two pawls placed, but normally manpower drive vehicle goes forward, so the wheel should rotate anticlockwise.

By pedaling the pedal on input shaft, Cheng-Ze mechanism can drive wheel rotating anticlockwise, which makes manpower drive vehicle go forward, and without pedaling the pedal, Cheng-Ze mechanism will let vehicle glide automatically; and when drive wheel is rotating clockwise, Cheng-Ze mechanism is locked and can not go back, so a spline coupling is mounted in the hole of output shaft and which can make output shaft and spline hole that is at the end of spline coupling engage and disengage instantly; and when a vehicle is running forward or gliding automatically, the spline coupling makes the output shaft and the spline hole that is at the end of the spline coupling engage; and when a vehicle need go back, the spline coupling can be drawn out thus the output shaft and the spline hole that is at the end of the spline coupling are disengaged, meantime the wheel is rotating clockwise, the reversal moment generated can not be transferred to the output shaft, then manpower drive vehicle can go back at will.

The pedal mechanism used to drive can be a mechanism in which pedal moves up and down linearly and perpendicularly, or another mechanism in which one pedal pole is pedaled with left and right foot alternately, or parallelogram pedal mechanism; and all of these mechanisms can easily realize the function of pedaling with left and right foot alternately, and transforming rider's whole body weight into driving force. But if taking the structure of pedal moving up and down linearly and perpendicularly, the distance between two aparted feet is constant and driving is stable, however, this kind of structure is too complicated, and bodywork gets heavier and pedal mechanism is easily collided with barriers on road; and if taking the structure of pedaling one pedal pole, it makes structure simplifier and bodywork lighter, but the distance between two aparted feet is various, and the pedal on the pedal pole is rotated too easily, and that let feet disengage from pedal easily, and people need time to adapt it; and if taking structure of parallelogram pedal, it makes pedal keep on level position all along and that let feet not easily disengage from it, and it makes driving very stably and this structure is not complicated, despite one more adjuvant pedal pole added, and the structure is a very sound pedal mechanism.

The advantages of this invention comparing with current technology are as follow: on condition of not consuming outside energy, a manpower drive vehicle driven only by weight can remarkably increase driving force and speed, and that reduces body energy consumed greatly comparing with current drive mode. For the diversity of vehicle status, road situation and rider's weight, it is hard to express the variation of driving force, speed and consumed body energy with some data exactly. But the advantage and superiority and practicability of this invention can be understood easily in comparing with physical phenomena of going upstairs and downstairs. During upstairs, force of weight must be overcome by leg force, and riding current manpower drive vehicle, force of friction and weight must be overcome by leg force. Going upstairs is same as riding bicycle, both consuming body energy to do work, but going down stairs is quite different from going up stairs, during going down stairs, people feel easy and downstairs quickly, which is the reason of force of weight working, so during going downstairs, people depend on the force of weight to reduce energy consumed and to improve capability of doing work greatly. Similarly, people can make use of the force of weight to do work conveniently and comfortably during riding bicycles, thus body energy consumed will be reduced and driving force will be increased greatly just like the fact of going down stairs. During riding bicycle, because body has no upward restriction, the maximal leg pedal force can not exceed body weight no matter how the rider exerts his leg strength. But if using Cheng-Ze mechanism to drive, the rider need not exert his leg strength to pedal. Under the action of the force of weight, riders need only tread even without pedaling, which can make the whole force of body weight act on the pedal and make driving force increased to the same as force of weight all along and then speed increased; and Second, transmission components in Cheng-Ze mechanism are all mounted inside a small closed box, which makes the structure simple and compact, and dustproof and waterproof, and lubrication sufficient, and driving reliable and efficient, and possess a various drive ratio which can be great or little, maintenance convenient and life duration longer.

As a practical example of this invention, the inventor developed two wheel bicycle driven by weight successfully. This kind of bicycle is based on current bicycle and it uses Cheng-Ze drive mechanism to replace the drive mechanism comprising crank, chain wheel and chain. Thus the goal that this kind of bicycle can be driven by body weight conveniently and comfortably can be attained. In order to carry or park conveniently and to reduce space it occupies, handlebar and bodywork are designed to be folding, and thus the two wheel weight bicycle folded can be put in a special bag and then carry conveniently or park in corner of house. The inventor names this manpower two-wheel vehicle driven by body weight as a weight bicycle. According to testing data, the inventor affirmed that performance of weight bicycle is superior to that of current bicycle.

This invented manpower vehicle driven by body weight uses a Cheng-Ze drive mechanism to replace the drive mechanism comprising crank, chain wheel and chain, and all of the body weight can act on the pedal, then the object of driving by weight can easily attained. There are superiorities such as consuming no outside energy, reducing the body energy consumed, increasing the driving force remarkably, and increasing the speed. The structure of Cheng-Ze drive mechanism is simple and compact, dustproof and waterproof, lubrication sufficient, driving reliable and high efficient, and its drive ratio can be great or little, and it can be maintained conveniently and it has a long life duration. Except for two-wheel bicycle, Cheng-Ze drive mechanism can be used in the three-wheel bicycle, four-wheel vehicle, water-bicycle, small boat, manpower aircraft, multiple manpower drive, manpower dynamotor, wave or tide dynamoelectric equipment and internal-combustion rotated axis.

### BRIEF DESCRIPTION OF THE DRAWINGS

FIG. 1 illustrates the wheel driving principle of the Cheng-Ze drive mechanism in which the input shaft's swing motion is transformed into the output shaft's in-one-way rotation.

FIGS. 2 and 3 illustrate the structure of the wheel box of the Cheng-Ze drive mechanism.

FIG. 4 illustrates the structure for realizing the function of the wheel running reversely.

FIG. 5 illustrates the structure of the pedal mechanism in which the pedals can be pedaled up and down perpendicularly.

FIG. 6 illustrates the structure of the pedal mechanism with one pedal pole.

FIG. 7 illustrates the structure of the pedal mechanism with parallelogram mechanism.

FIG. 8 illustrates the embodiment of two wheel bicycle with Cheng-Ze drive mechanism which driven by body weight.

FIG. 9 illustrates the folding structure of handlebar.

FIG. 10 illustrates the two-fold structure of bodywork.

### DETAILED DESCRIPTION OF THE PREFERRED EMBODIMENT

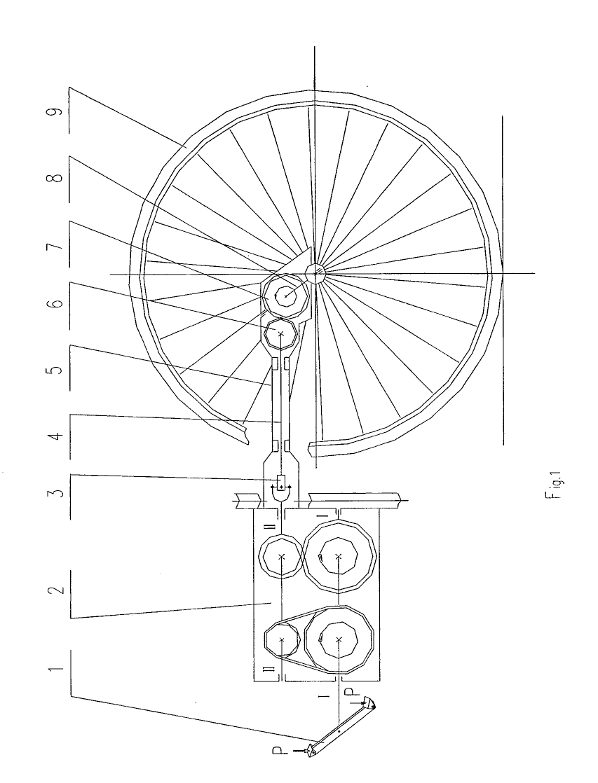

The Cheng-Ze drive mechanism illustrated in FIG. 1 is the key structure to realize the object of this invention. On the input shaft (I-I), which is extended from the front of the wheel box (2) that is airproof well, the pedal mechanism (1) for driving is mounted, wherein the pedals can be pedaled up and down alternately with left and right foot; and on the output shaft (II-II), which is extended from the back of the wheel box (2), a coupling (3) and a force-transmitting link (4) are mounted; and a pair of bevel gears (or annular gears) (6) and (7) are mounted on the other end of the force-transmitting link (4) and the wheel shaft (8) respectively; and the output shaft (II-II), the coupling (3), the force-transmitting link (4) and the bevel gears (6) and (7) are all mounted inside the closed box (5); and the wheel box (2) and the wheel shaft (8) are connected through the closed box (5); and the working principle is that if left and right foot pedal the pedal (1-3) or (1-6) or (1-8) (illustrated in FIGS. 5, 6, 7) of pedal mechanism (1) up and down alternately, the input shaft (I-I) inside the wheel box (2) will alternately swing from left to right under the action of body weight, and then the output shaft (II-II) will rotate clockwise all along; and the drive moment generated from the output shaft (II-II), through the coupling (3), the force-transmitting link (4), a pair of bevel gears (or annular gears) (6) and (7), finally drives the wheel (9) rotate anticlockwise and makes manpower vehicle run forward.

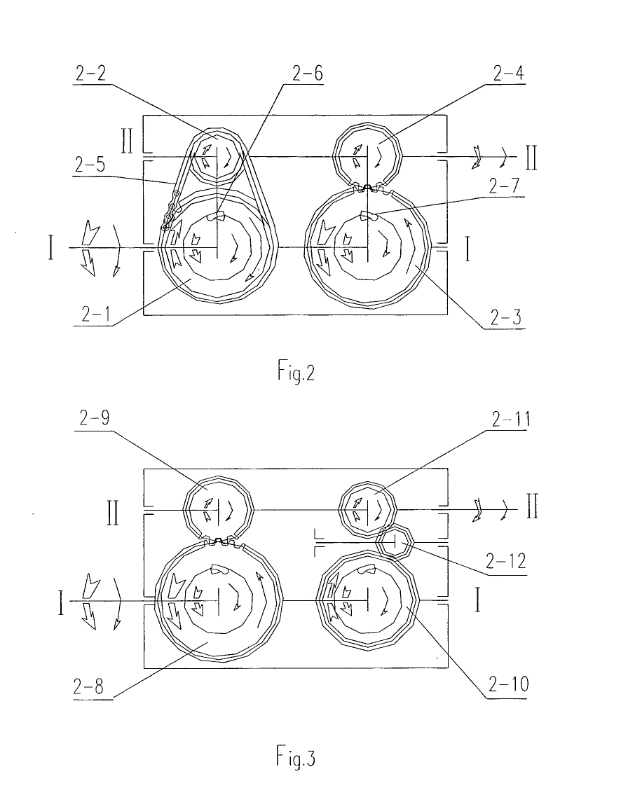

FIGS. 2 and 3 are the two embodiments about Cheng-Ze mechanism in which the left-right swing motion of the input shaft (I-I) is transformed into the one-way rotation of the output shaft (II-II); and in Cheng-Ze mechanism illustrated in FIG. 2, the input shaft (I-I) and the output shaft (II-II) run parallel in the wheel box (2), and on the input shaft (I-I), the chain wheel (2-1) with pallet (2-6) and the gear (2-3) with pallet (2-7) are mounted, and the outer ring of the pallet (2-6) can rotate clockwise, and the outer ring of pallet (2-7) can rotate anticlockwise; and on the output shaft (II-II), the chain wheel (2-2) and the gear (2-4) are mounted correspondingly, and chain wheel (2-1) and the chain wheel (2-2) are driven by the chain (2-5), the gear (2-3) and (2-4) are meshed to each other; and when the input shaft (I-I) rotates clockwise according to thin arrowhead, and the chain wheel (2-1) drives the chain wheel (2-2) through the chain (2-5) and makes the output shaft (II-II) rotate clockwise, then the gear (2-3) rotates idly and transfers no drive moment due to the function of the pallet (2-7), thus when the input shaft (I-I) rotates anticlockwise according to the thick arrowhead, the gear (2-3) drives the gear (2-4) to make the output shaft (II-II) rotate clockwise, too, and meantime the chain wheel (2-1) turns idly and transfers no drive moment due to the function of the pallet (2-6), thus when the input shaft I-I swings from left to right alternately, the output shaft (II-II) rotates clockwise continuously.

If the pallet (2-6) and the pallet (2-7) orientate in reverse direction respectively contrast to FIG. 2, thus when the input shaft (I-I) swings from left to right alternately, the output shaft (II-II) rotates anticlockwise continuously, but this is reverse to the direction needed by manpower vehicle driving to run, it is not practical.

Among the four kinds of structures formed by different combinations with pallet setting and orientating illustrated as FIG. 2, only two combinations can make the output shaft (II-II) rotate clockwise or anticlockwise continuously, and among the other four kinds of structures formed by different combination with pallet setting on the chain wheel (2-1) and the gear (2-4), there are also two combinations can make the output shaft (II-II) rotate clockwise or anticlockwise continuously, except these combinations, no combinations can make the input shaft (I-I) swing from left to right alternately and the output shaft (II-II) rotate clockwise or anticlockwise continuously.

The chain wheel (2-1) and the chain wheel (2-2) illustrated in FIG. 2 and FIG. 3 can be replaced by strap wheel or tooth-like wheel or rope wheel, and the pallet (2-6) and pallet (2-7) also can be roller or eccentric fan-shaped except the common structure illustrated in FIG. 2, but their transmission principles are same. In FIG. 3, the gear (2-8) with pallet and gear (2-10) with pallet are mounted on the input shaft (I-I), but the pallet's orientation are reverse to that showed in FIG. 2, and on the output shaft (II-II), the gear (2-9) and the gear (2-11) are mounted respectively, and the gear (2-8) and the gear (2-9) are meshing to each other, and the gear (2-10) and the gear (2-11) are driven by meshing to the middle gear (2-12), but the mechanism's transmission principle is same as that in FIG. 2; and the inventor thinks the structure illustrated in FIG. 2 is rather sound which comprises chain wheel, chain and gear or tooth-like wheel, tooth-like strip and gear. According to use performance of mechanism or equipment, different transmission ratio can be obtained by changing dimensions of chain wheel (2-1), (2-2) and gear (2-3), (2-4).

FIG. 4 illustrates the structure whose function is to make the wheel go back. The spline coupling (14) fits in inner hole of the output shaft (II-II) and a spline hole in the end of the spline universal coupling (15) can transfer drive moment when they are fitting well under the action of compress spring (13). When spline coupling 14 is drawn out as that illustrates in FIG. 4, then it will divorce from spline hole in end of spline universal coupling (15), and the rotation moment which drives the wheel (9) running back can not be transferred to the output shaft (II-II), So when the wheel (9) rotates clockwise, the manpower vehicle can go back.

FIG. 5 illustrates the structure of perpendicularly up and down pedal mechanism, the chain wheel(1-1), or tooth-like wheel, or rope wheel is mounted on the front of the input shaft (I-I), and the pedal (1-3) connects with the chain(1-2), or a timing belt, or a steel wire by the glide block (1-4). If the pedal (1-3) is pedaled with left and right foot alternately, it will move up and down perpendicularly along left or right guide (1-5) under the action of the force of body weight, thus the input shaft (I-I) rotates left and right alternately continuously, meantime, all force of body weight acting on the pedal perpendicularly will be turned into drive moment and this moment will be inputted the wheel box (2), and then outputted from the output shaft (II-II).

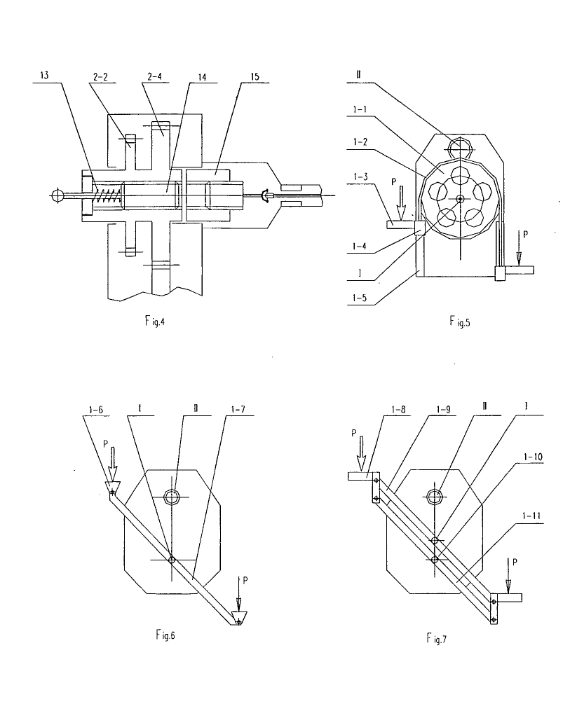

FIG. 6 illustrates the structure of pedal mechanism with one pedal pole. The pedal pole (1-7) is mounted on the front of the input shaft (I-I), and the pedal (1-6) is hinged with two ends of the pedal pole (1-7), and when left and right foot alternately pedals the pedal (1-6), all of the force of body weight can be turned into drive moment.

FIG. 7 illustrates the structure of parallelogram pedal mechanism. The pedal pole (1-9) is mounted on the front of the input shaft (I-I), and the accessorial pedal pole (1-11) is hinged with the support shaft (1-10), and the pedal (1-8) is hinged with the two ends of both the pedal pole (1-9) and accessorial pedal pole (1-11), then when left and right foot alternately pedal the pedal (1-8), all of the force of the body weight can be turned into drive moment.

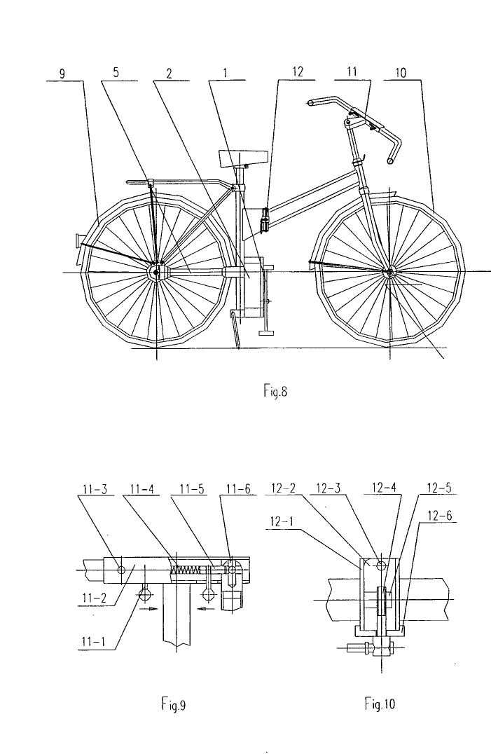

FIG. 8 illustrates an embodiment of two wheel weight bicycle. It is based on the current two wheel bicycle, wherein Cheng-Ze drive mechanism replaces current drive mechanism comprising crank, chain wheel and chain. In FIGS. 8 and 1, number 1 denotes the pedal mechanism, number 2 denotes wheel box, number 5 denotes supporting pipe. Inside the closed support pipe (5), the spline coupling (15) and the universal (3), and the force-transmitting link (4), and the bevel gears (or annular gears) (6) and (7) are all mounted. The bodywork and handlebar of the weight bicycle invented as an embodiment are designed to be folding.

FIG. 9 illustrates the folding structure of the handlebar (11). The handlebar (11-6) is hinged with the folding seat (11-2) through the hinge shaft (11-3) and rotates around the shaft (11-3). The fixing pin (11-5) is inserted into the hole of the handlebar (11-6) under the action of the thrust force produced by the spring (11-4). By dragging button hand (11-1), fixing pin (11-5) can disengage from fixing hole on the handlebar (11-6), then the function of folding or unfolding the handlebar (11-6) can be attained.

FIG. 10 illustrates the folding structure (12) about two-double bodywork. The front foldout (12-1) is hinged with the back foldout (12-2) through the hinge shaft (12-3). The bolt (12-4) and the nut block (12-5) are used to fold or unfold the bodywork work through the fixing board (12-6).

Except this embodiment of weight two-wheel bicycle, for the other embodiments of manpower drive vehicle, such as three-wheel-vehicle, four-wheel-vehicle, water-bicycle and manpower aircraft, etc., the technicians of this field can use Cheng-Ze drive mechanism to replace the drive mechanism comprising crank, chain wheel and chain, and the function of driving by body weight can be easily attained. The setting methods and modes are same as that of two-wheel weight bicycle, which are not described especially here.

1. A manpower vehicle driven by weight, characterized in that, includes a drive mechanism called Cheng-Ze drive mechanism, which can transform input shaft's swing motion into output shaft's unilateral rotation, wherein the input shaft and the output shaft run parallel; and a pedal mechanism for driving(1), mounted on the input shaft (I-I) which is extended from the front of a well-airtight wheel box (2), which can be pedaled up and down alternately with the left and right foot; and a coupling (3), connected with a force-transmitting link (4) on the output shaft (II-II), which is extended from the back of the wheel box (2); and a pair of bevel gears (6) and (7), mounted on the other end of the force-transmitting link (4) and the wheel shaft (8) respectively; and pedals (1-3) or (1-6) or (1-8) of the pedal mechanism, when these are continually pedaled by the left and right foot (1) up and down, that is, under the action of weight, the input shaft (I-I) in the wheel box (2) is continually driven to swing from left to right by turns, thus to drive the output shaft (II-II) rotate clockwise all along; and a wheel (9), driven by the drive moment which is generated from the output shaft (II-II), to pass through the universal coupling (3), the force-transmitting link (4) and the pair of bevel gears (6) and (7) to rotate anti-clockwise, that is, this manpower vehicle runs forward.

2. The manpower vehicle driven by weight in claim 1, characterized in that, said Cheng-Ze drive mechanism, wherein the structure in the wheel box (2) is that the input shaft (I-I) and the output shaft (11-11) run parallel; and a chain wheel (2-1) with a pallet structure (2-6) and a gear (2-3) with pallet structure(2-7), fixed on the input shaft (I-I), wherein the outer ring of the pallet (2-6) on the chain wheel (2-1) can rotate clockwise and the outer ring of pallet (2-7) on the gear(2-3) can rotate anti-clockwise; and a chain wheel (2-2) and a gear (2-4), correspondingly fixed on the output shaft (II-II); and the chain wheel (2-1) and the chain wheel (2-2), driven by chain (2-5); and the gear (2-3) and the gear (2-4), driven by meshing with each other; and the chain wheel (2-1), when the input shaft (I-I) rotates clockwise, drives chain wheel (2-2) by chain (2-5), that drives the output shaft (II-II) to rotate clockwise, here, the gear (2-3) turns idly and transfers no moment due to the action of the pallet (2-7) despite the gear (2-3) and the gear (2-4) meshed well; and the gear (2-3), when input shaft (I-I) rotates anti-clockwise, drives the gear (2-4), so that the output shaft (II-II) is driven to rotate clockwise too, here, chain wheel (2-1) turns idly and transfers no moment due to the action of the pallet (2-6), thus the input shaft (I-I) swings from left to right alternately, that drives output shaft (II-II) to rotate clockwise and continuously.

3. The manpower vehicle driven by weight in claim 1, characterized in that, said Cheng-Ze drive mechanism, wherein the direction of the chain wheel (2-1) mounted on the input shaft (I-I) and the direction of two pallet on the gear (2-3) are mounted in reverse respectively, that is, the input shaft (I-I) swing from left to right alternately and the output shaft (II-II) continuously rotates clockwise all along.

4. The manpower vehicle driven by weight in claim 1, characterized in that, said Cheng-Ze drive mechanism, wherein the chain wheel (2-1) with the pallet structure and the gear (2-3) without the pallet structure are fixed on the input shaft (I-I), correspondingly, the chain wheel (2-2) without the pallet structure and a gear (24) with the pallet structure are fixed on the output shaft (11-11); and the two pallet on the chain wheel, mounted in facing or reverse direction, that is, the input shaft (I-I) swings from left to right alternately and the output shaft (II-II) continuously rotates clockwise or anti-clockwise all along.

5. The manpower vehicle driven by weight in claim 1, characterized in that, said Cheng-Ze drive mechanism, wherein the chain wheel (2-1) on the input shaft (I-I) and the chain wheel (2-2) on the output shaft (II-II) are strap wheels or tooth-like wheels or rope wheels; and the pallet (2-6) and the pallet (2-7), being the type of roller friction or eccentric fan-shaped friction.

6. The manpower vehicle driven by weight in claim 1, characterized in that, said output shaft (II-II), coupling (3), force-transmitting link (4) and pair of bevel gears (6) and (7), all mounted in a close closed pipe (5); and the wheel box (2) and wheel shaft (8), connected by the closed pipe (5).

7. The manpower vehicle driven by weight in claim 1, characterized in that, the pair of bevel gears (6) and (7), being a pair of annular gears.

8. The manpower vehicle driven by weight in claim 1, characterized in that, said Cheng-Ze drive mechanism, wherein a gear (2-8) with pallet and a gear (2-10) with pallet are fixed on the input shaft (I-I); and the pallet on the two gears, mounted in facing or reverse direction; and a gear (2-9) and a gear (2-11), accordingly, fixed on the output shaft (II-II); and the gear (2-8) on the input shaft (I-I) and the gear (2-9) on the output shaft (II-II), driven by meshing with each other; and the gear (2-10) on the input shaft (I-I) and the gear (2-11) on the output shaft (II-II), driven by meshing with each other through a middle gear (2-12); or a gear (2-8) with pallet structure and a gear (2-10) without pallet structure, fixed on the input shaft (I-I); and a gear (2-9) without pallet structure and a gear (2-11) with the pallet structure, fixed on the output shaft (II-II); and the pallet on the two gears, mounted in facing or reverse direction, that is, the input shaft (I-I) swings from left to right alternately and the output shaft(II-II) continuously rotates clockwise or anti-clockwise all along.

9. The manpower vehicle driven by weight in claim 1, characterized in that, said Cheng-Ze drive mechanism, wherein different transmission ratio can be gained by selecting different fitting dimension of the chain wheel (2-1),(2-2) and the gear (2-3),(2-4).

10. The manpower vehicle driven by weight in claim 1, characterized in that, said Cheng-Ze drive mechanism, wherein a spline coupling (14) is fitted in inner hole of the output shaft (II-II); and a thin pole, extending out from the left end of the spline coupling; and a compress spring (13) is mounted on the thin pole; and the compress spring, gored on the left end face, that is, the spline coupling (14) can move forward and backward along the axle, or fit in the spline hole on one end of a spline universal coupling (15) and transfer drive moment, or disengage from the spine hole on one end of the spline universal coupling (15), that is, a wheel (9) rotates clockwise and manpower vehicle runs back.

11. The manpower vehicle driven by weight in claim 1, characterized in that, the structure of the pedal mechanism used to drive, being that the chain wheel (1-1) is mounted on the input shaft and the chain (1-2) is coiled around the wheel; and the pedals (1-3) are mounted respectively on two ends of chain (1-2), thus the pedals (1-3) move up and down linearly.

12. The manpower vehicle driven by weight in claim 11, characterized in that, said chain wheel (1-1), replaced by a tooth-like wheel or a rope wheel; and said chain (1-2), replaced by a tooth-like strip or a steel rope accordingly.

13. The manpower vehicle driven by weight in claim 1, characterized in that, the structure of the pedal mechanism (1) used to drive, being that a pedal pole (1-7) is mounted on the input shaft; and the pedal (1-6) is hinged with two ends of the pedal pole (1-7).

14. The manpower vehicle driven by weight in claim 1, characterized in that, the structure of the pedal mechanism (1) used to drive, being that the pedal pole (1-9) is mounted on the input shaft; and a accessorial pedal pole (1-11), run parallel and deviated with a proper distance to the pedal pole (1-9); and the pedals (1-8), hinged with ends of the pedal pole (1-9) and the accessorial pedal pole (1-11) respectively.

15. The manpower vehicle driven by weight in claim 1, characterized in that, further includes a handle module (11) with a folding structure, comprising: a fold seat (11-2), a shaft (11-3), a handlebar (11-6), a fixing pin (11-5), a spring (11-4) and a drawing button handle (11-1); and the shaft (11-3), mounted on the vicinity of two ends of the fold seat (11-2) respectively; and the end of the handlebar (11-6), plugged into the fold seat (11-2) and rotating around the shaft (11-3); and the end of said handlebar(11-6), having throughout holes in level and perpendicularity; and the spring (1-4), goring and pressing one end of the fixing pin (11-5) in level, that is, the other end of the fixing pin (11-5) is plugged into the level or perpendicularity throughout holes on the end of the handlebar (11-6) correspondingly; and the drawing button hand (11-1), mounted on said fixing pin (11-5) perpendicularly to the axle fast.

16. The manpower vehicle driven by weight in claim 1, characterized in that, Cheng-Ze drive mechanism can be used in the two-wheel bicycle, three-wheel bicycle, four-wheel vehicle, water-bicycle, small boat, manpower aircraft, multiform manpower drive, manpower dynamotor, wave or tide dynamoelectric equipment and internal-combustion rotated axis.
